(19) United States
(12) Patent Application Publication
(10) Pub. No.: US 2014/0331904 A1
(43) Pub. Date: Nov. 13, 2014

(54) PRODUCTION BENCH

(71) Applicant: EDSAL MANUFACTURING COMPANY, INC., Chicago, IL (US)

(72) Inventors: Anthony J. Troyner, Shorewood, IL (US); David J. Wojtowicz, Orland Park, IL (US)

(73) Assignee: EDSAL MANUFACTURING COMPANY, INC., Chicago, IL (US)

(21) Appl. No.: 14/273,644

(22) Filed: May 9, 2014

Related U.S. Application Data
(60) Provisional application No. 61/821,865, filed on May 10, 2013.

(51) Int. Cl. B25H 1/02

(52) U.S. Cl. CPC B25H 1/02
USPC 108/153.1; 29/525.11

(57) ABSTRACT

A tubular frame of rectangular cross-section members with adjacent respective ends positioned to abut a square cross-section leg. A bolt plate is welded across the two members proximate the ends and a bolt extends therethrough to a leg locking plate within the leg. A slot at a leg corner accommodates the bolt.

On tightening the bolt, the leg locking plate engages respective interior surfaces of the leg, drawing and holding it against the ends of the frame member. Frame members are secured to the bench top defining four corners, each having a leg similarly secured thereto. Methods are included.

### PRIORITY CLAIM

Priority of the U.S. Provisional Application Ser. No. 61/821,865, filed May 13, 2013 is claimed and that application incorporated herein in its entirety by this reference.

### FIELD OF THE INVENTION

This invention relates to benches and more particularly supporting legs and frames for work benches.

### BACKGROUND OF THE INVENTION

Benches, and particularly work benches, typically include a bench top and leg apparatus supporting the bench top. It is desired to provide a stable work surface in the form of a bench top. The construction and attachment to the top of the supporting legs is significant to bench stability. Particularly when work benches are produced in knockdown form, the assembly of legs and any support frame is a potential weak point or weak link in providing the desired stability. Moreover, it is desired to provide bench top, frame and legs in an easy to assemble package, yet also providing, when assembled, a stable bench.

Accordingly, it is desired to provide a work bench in a knockdown easily assembled package or kit wherein the bench, when erected, provides a stable work surface.

### SUMMARY OF THE INVENTION

A preferred embodiment of the invention includes a bench top, a top frame and a plurality of legs, all of which are assembled together to provide a stable bench. A rectangular top frame is comprised of four side frame members of rectangular cross-section and having spaced-apart ends. Adjacent frame ends are slightly spaced apart and are connected together with a bolt plate welded at each end, at a 45 degree angle, to each adjacent side frame member and having a bolt hole extending toward a corner defined by the two adjacent ends of the frame members. A leg locking plate is threaded on the end of each bolt, parallel to the bolt plate and preferably spaced from each end of the adjacent frame members.

A leg of preferably square cross-section is disposed in the corner defined by the ends of the adjacent frame members, a respective side of each leg against an end of a respective side member. The leg locking plate is disposed within the leg, with ends of the leg locking plate respectively engaging internal surfaces of the leg sides disposed against the ends of the frame members. The leg top is disposed on the underside of the table.

An elongated slot at one corner of the upper end of the leg accommodates the bolt, extending therethrough to the leg locking plate.

When the bolt held by the bolt plate is turned, the leg locking plate is pulled into tight engagement with the internal surfaces of the leg adjacent ends of two respective frame members biasing the respective leg sides against the adjacent frame member ends.

Once finally tightened, a respective leg is thus locked at the four corners of the frame, tightly against ends of the adjacent frame members.

This construction provides a very strong and stable attachment of leg to frame and results in a very stable bench when the frame is secured to a bench top by brackets (not shown) securing the frame members to the bench top.

While the leg is preferably of square cross-section, it may alternately comprise a two-sided structural angle.

This construction and assembly are further clearly described in the drawings wherein:

### BRIEF DESCRIPTION OF THE DRAWINGS

FIG. 1 is an isometric view of a frame and leg joint of the invention viewed from the underside of a bench;

FIG. 2 is an isometric view of ends of two adjacent frame members welded together by the bolt plate and illustrating the bolt and the leg locking plate and with the leg omitted for clarity;

FIG. 3 is an isometric view similar to FIGS. 1 and 2 but also illustrating the assembly of a top end of a leg with a bolt-accommodating slot therein to the frame;

FIG. 4 is a top plan view in partial end view cross-section showing the final attachment of a leg to a frame corner defined by ends of two adjacent frame members and further illustrating a bolt plate, and bolt and leg locking plate securing the leg to the frame member ends; and

FIG. 5 is an isometric view similar to FIG. 1 but illustrating the assembly of a leg to two frame members by tightening the bolt.

These figures illustrate the above described components oriented on the underside 16 of a bench top 18, the frame members secured thereto by any suitable clips 8, 10, brackets or fasteners.

Further describing the invention are the following written descriptions:

### DETAILED DESCRIPTION

Turning now to the drawings there is shown in the FIGS. the structural elements of the invention.

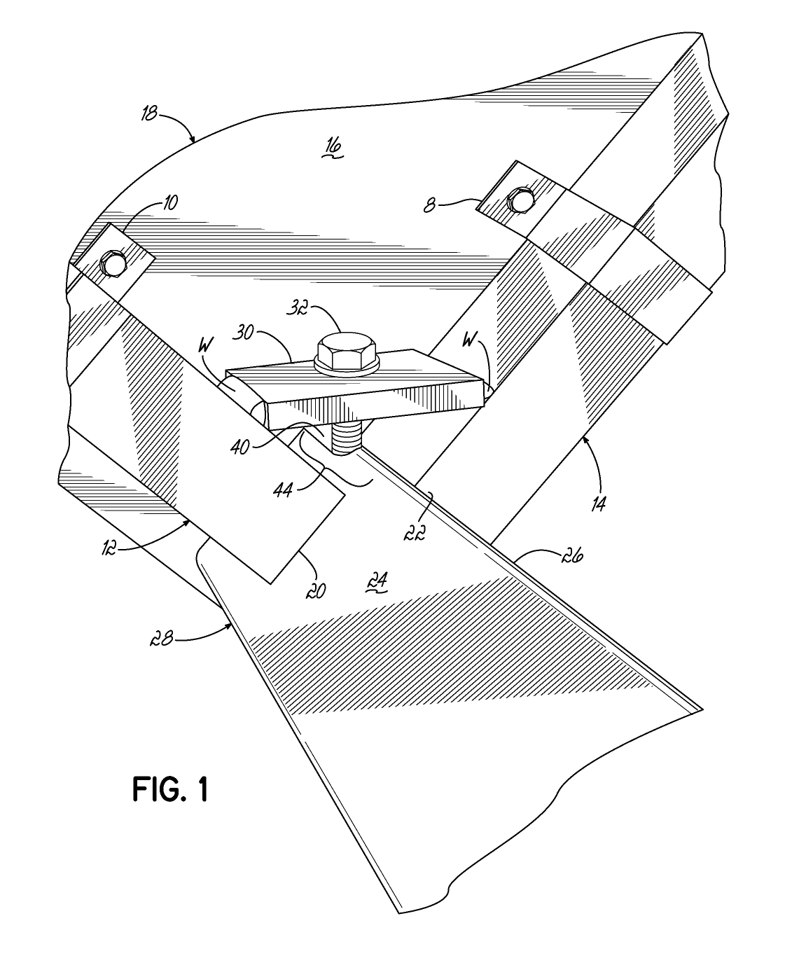

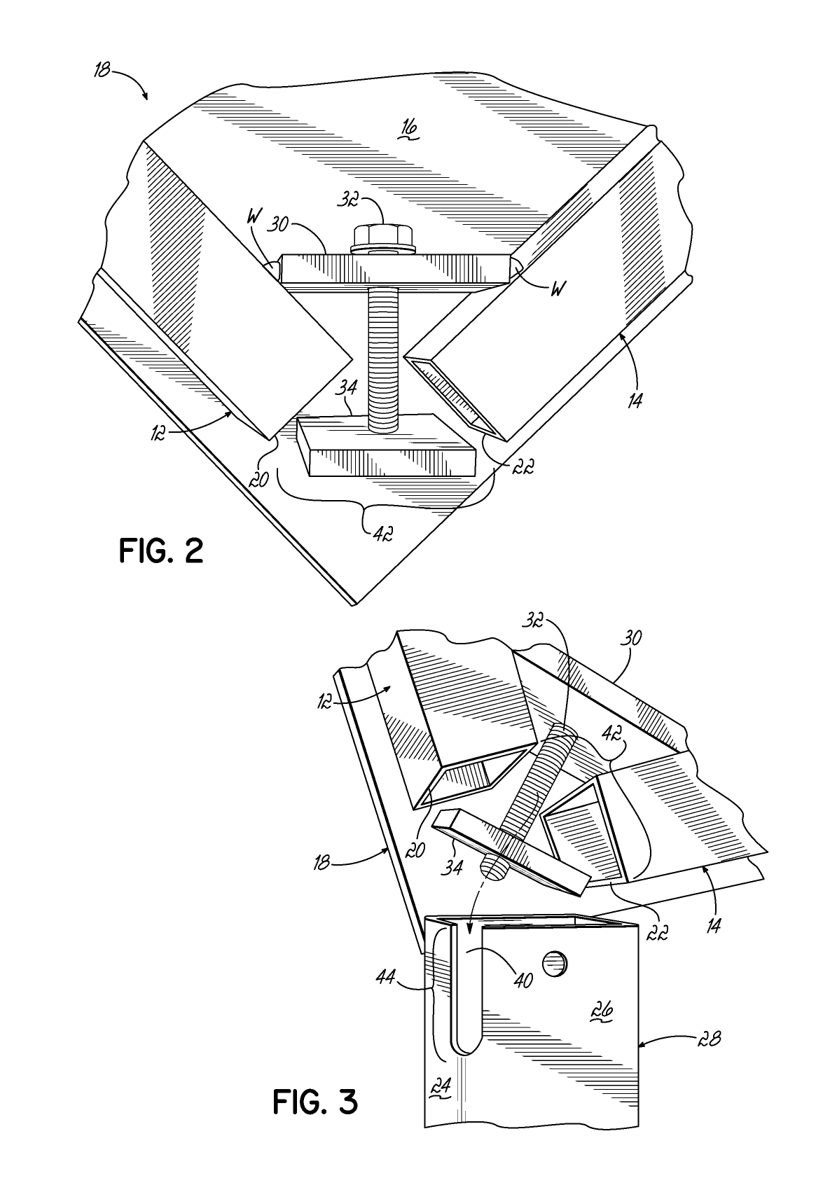

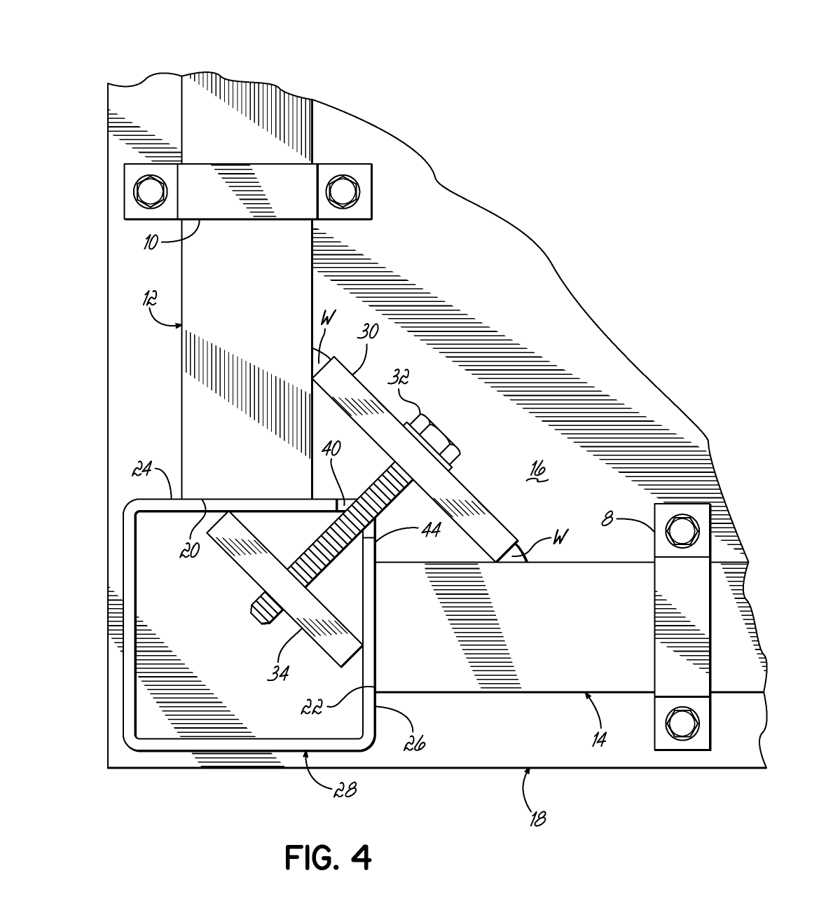

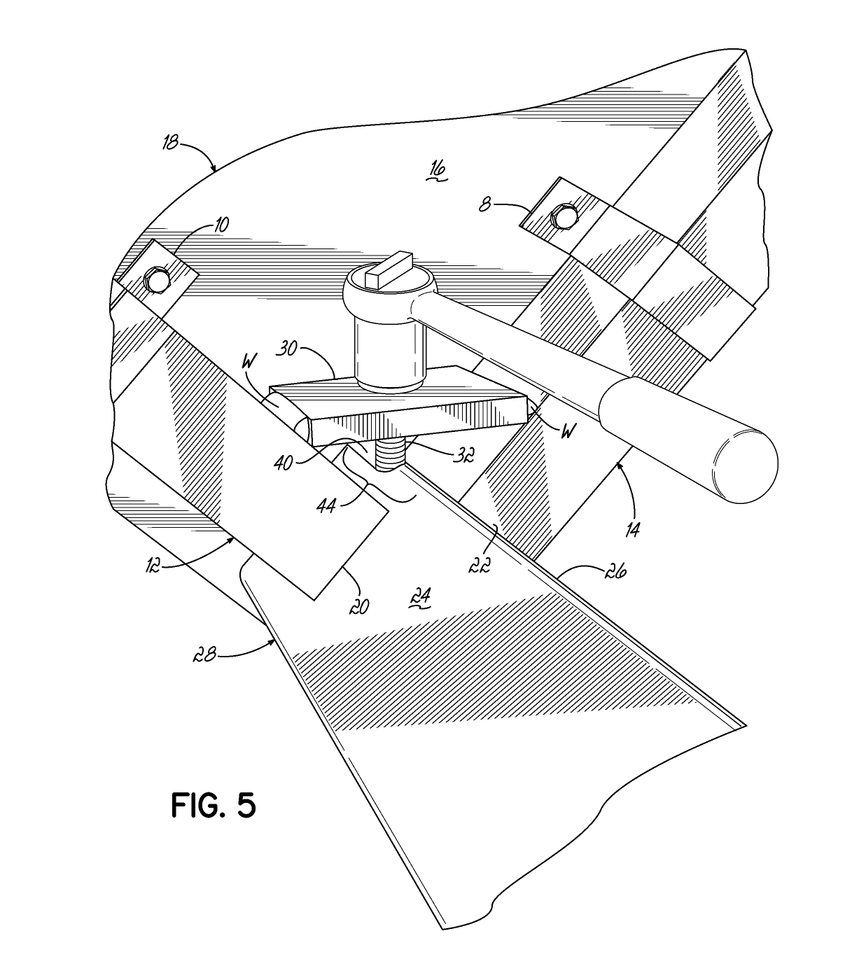

In FIG. 1, a pair of perpendicular, hollow frame members 12, 14 are disposed against the underside 16 of a bench top 18, at a corner thereof. Each frame member 12, 14 has a respective end 20, 22 (best seen in FIGS. 2-4) adjacent and engaging a respective outer side 24, 26 of a leg 28 shown in square cross-section (FIG. 4). The frame members are each secured to the underside 16 of a bench top 18 or table by straps 8, 10, brackets, clips or other suitable means.

A bolt plate 30 is welded (at W) to the preferably perpendicular frame members 12, 14 at respective 45° angles thereto. A bolt 32 extends through bolt plate 30 into leg locking plate 34 (FIGS. 2-4), such that turning bolt 32 draws leg locking plate toward the bolt plate 30.

Leg locking plate 34 has ends 36, 38 engaging interior surfaces of leg sides 24, 26 (see FIG. 4). Bolt 32 extends through an elongated slot 40, extending along the corner 42 formed by perpendicular sides 24, 26 of leg 28.

In use, frame members 12, 14 are disposed perpendicularly to each other with ends 20, 22 adjacent but not touching and defining a corner area 44. Bolt plate 30 is preferably welded at its ends to frame members 12, 14 as shown and bolt 32 extended therethrough to leg locking plate 34.

Leg 28 has an end provided with slot 40 and this end is inserted into corner area 44 with slot 40 disposed over bolt 32 and leg surfaces 24, 26 in loose engagement with respective ends 20, 24 of frame members 12, 14. Leg locking plate is there tightened against the inside surfaces opposite surfaces 24, 26 to draw the leg 28 into corner 44 tightly against frame member ends 20, 22 (FIG. 5), securing leg 28 tightly to frame members 12, 14. The top end of the leg 28 is disposed against the underside 16 of table top 18.

It will be appreciated that frame members 12, 14 are preferably of rectangular, non-square cross section, with shorter opposite sides parallel to top 18 and larger opposite sides extending perpendicularly to top 18. In this regard, leg locking plate 34 is also preferably of rectangular, non-square configurations so its longer edges engage the inside of surfaces 24, 26 of leg 28, providing a long engagement with the leg 28. Leg locking plate 34 is sized preferably so it engages the interior surfaces of leg 28 between the engagement therewith of the opposed end edges of the respective frame members as shown. Thus the forces applied to the leg 28 by leg locking plate 34 are applied centrally of the engaged edges of the hollow frame members 12, 14, providing a strong engagement of leg to frame.

As illustrated in FIG. 5, a ratchet driver socket is used to engage bolt 32 for tightening leg locking plate 34 internally and against ends 22, 24 of frame members 12, 14.

There is thus provided structure for providing and assembling a strong and sturdy bench from an unassembled hit of frame and legs for a bench top, with four frame members 12, 14 (two preferably shorter than two others) of four equal length legs, are for each corner of the bench.

Other bench configurations of rectangular or other multiple sided benches can be formed by use of the invention and appropriately sized and assembled frame members of various multiples such as three, six, eight sided benches, etc. with respective frame member ends and appropriately configured bolt plates welded at required angles thereto.

It will be appreciated that assembly may be facilitated by placing on intended bench top horizontally and first affixing the frame members 12, 14 thereto with brackets 8,10, clips, fasteners or other means, then assembling the legs to the adjacent ends of the frame members.

What is claimed is:

1. A bench having a support frame and legs attached to said frame, said bench including:
at least two frame members each with an end disposed proximate the end of an adjacent frame member;
a bolt plate extending across said at least two frame members;
a bolt extending through said bolt plate;
a leg having at least two sides each engaging a respective end of said at least two frame members;
a leg locking plate in said leg, engaging said leg and operably connected to said bolt for drawing said leg against said ends of said at least two frame members when said bolt is tightened on said bolt plate.

2. A bench as in claim 1 wherein said bolt plate connects said at least two frame members to one another at an angle of 90 degrees.

3. A bench as in claim 1 wherein said leg has an upper end and said at least two leg sides joined at an angle, further including a slot proximate an apex of said angle for accommodating said bolt.

4. A bench as in claim 1 further including a bench top, said frame secured to said bench top.

5. A bench as in claim 1 wherein the leg locking plate is rectangular with complimentary long and short edges, said long edges engaging surfaces, respectively, of said leg.

6. A method of assembling supporting legs to frame members to form a bench, said method including the steps of:
orienting at least two frame members at an angle to each other, each member having an end oriented adjacent to but spaced from the end of another member;
securing a bolt plate to each of said two frame members, orienting a leg locking plate spanning an area between said ends;
extending a fastener through said bolt plate and said leg locking plate;
orienting a hollow end of a leg end between said ends with said leg locking plate within said leg end; and
drawing said leg locking plate into engagement with internal surfaces of said leg of biasing said leg against said ends of said two frame members.
